(19) United States
(12) Patent Application Publication
(10) Pub. No.: US 2014/0004895 A1
(43) Pub. Date: Jan. 2, 2014

(54) DATA TRANSMITTING METHOD FOR MACHINE TYPE COMMUNICATION (MTC) SERVICE AND COMMUNICATION APPARATUS USING THE SAME

(71) Applicant: Electronics & Telecommunications Research Institute, Daejeon (KR)

(72) Inventors: Young Seog SONG, Daejeon (KR); Moon Sik LEE, Daejeon (KR); Jun Hwan LEE, Seoul (KR); Il Gyu KIM, Chungcheongbuk-do (KR); Hyun Kyu CHUNG, Daejeon (KR)

(21) Appl. No.: 13/904,820

(22) Filed: May 29, 2013

(30) Foreign Application Priority Data
Jun. 27, 2012 (KR) 10-2012-0069232

(51) Int. Cl. H04W 4/00

(52) U.S. Cl. CPC H04W 4/005
USPC 455/509

(57) ABSTRACT

Provided are a method for data transmission between a narrow band device and a wide band device, and a communication system using the method. A data transfer method for machine type communication (MTC) service, in which an MTC device transmits/receives data to/from a base station, includes: setting a frequency band allocated to the MTC device in a frequency band supported by the base station, to a transmission and reception frequency band; and transmitting/receiving data to/from the base station through the transmission and reception frequency band. Accordingly, since a base station supporting a wide band and an MTC device supporting a narrow band transmit/receive data through an allocated frequency band, effective data transmission and reception between the base station and the MTC device is possible.

### CLAIM FOR PRIORITY

This application claims priority to Korean Patent Application No. 10-2012-0069232 filed on Jun. 27, 2012 in the Korean Intellectual Property Office (KIPO), the entire contents of which are hereby incorporated by reference.

### BACKGROUND

1. Technical Field

An example embodiment of the present invention relates in general to machine type communication (MTC) service, and more specifically, to a method for data transmission between a narrow band device and a wide band device, and a communication system using the method.

2. Related Art

Machine type communication (MTC) provides a network connected to all objects, and is a form of data communication which involves one or more entities that do not necessarily need human interaction. MTC includes machine-to-machine (M2M) communication, machine-oriented communication (MOC), and a ubiquitous sensor network (USN).

Service optimized for MTC differs from service optimized for human-to-human communication. In comparison with a current mobile network communication service, MTC service can be characterized by a) several market scenarios, b) data communication, c) lower cost and less effort, d) a potentially very large number of communicating terminals, e) a wide service area, and f) very small traffic per terminal.

MTC may appear in various service forms. An MTC scheme is a primary issue in the fields of remotely controlling gas metering or water metering known as smart metering, tracking and tracing, remote maintenance and control of, for example, vending machines, distribution management, remote monitoring of machines and equipment, healthcare, people tracing, water quantity or water analysis, etc.

Meanwhile, a Long Term Evolution (LTE)-based mobile communication system uses Orthogonal Frequency Division Multiplexing (OFDM) to support scalable bandwidths of 1.4 MHz, 3 MHz, 5 MHz, 10 MHz, 15 MHz, and 20 MHz. In the LTE-based mobile communication system, which was designed for general mobile phone or smart phone users, each base station has only to support one of the scalable bandwidths according to a frequency band allocated to a mobile communication carrier, but terminals have to support all bandwidths at which base stations operate.

Also, a LTE-Advanced based mobile communication system uses a multi-carrier transmission scheme, wherein each carrier occupies a bandwidth among 1.4 MHz, 3 MHz, 5 MHz, 10 MHz, 15 MHz, and 20 MHz. Accordingly, terminals that support LTE-Advanced should be able to receive a bandwidth of at least 20 MHz, and also receive multiple carriers.

As such, in the LTE or LTE-Advanced based mobile communication system, terminals that have to support a bandwidth of 20 MHz support relatively low-speed data since they require very high power consumption, and accordingly, such terminals cannot be appropriately used as MTC devices that should be used for several years or more after once charged.

Also, in order to enable an MTC device supporting a narrow band (for example, 1.4 MHz, 3 MHz, etc.) to access a LTE or LTE-Advanced base station supporting a wide band (for example, 20 MHz, etc.) and exchange data with the LTE or LTE-Advanced base station, an existing data transmission method needs to be changed.

### SUMMARY

Accordingly, example embodiments of the present invention are provided to substantially obviate one or more problems due to limitations and disadvantages of the related art.

An example embodiment of the present invention provides a method for data transmission between a narrow band device and a wide band base station.

Another example embodiment of the present invention also provides a communication apparatus using a method for data transmission between a narrow band device and a wide band base station.

In an example embodiment, there is provided a data transmission and reception method for machine type communication (MTC) service, in which an MTC device transmits/receives data to/from a base station, including: setting a frequency band allocated to the MTC device in a frequency band supported by the base station, to a transmission and reception frequency band; and transmitting/receiving data to/from the base station through the transmission and reception frequency band.

The setting of the frequency band allocated to the MTC device to the transmission and reception frequency band may include setting a frequency band allocated to the MTC device to a transmission and reception frequency band, based on band information received from the base station or based on unique information stored in the MTC device.

The setting of the frequency band allocated to the MTC device to the transmission and reception frequency band may include: receiving band information from the base station through a broadcast channel; and setting a frequency band allocated to the MTC device to a transmission and reception frequency band, based on the band information.

The transmitting/receiving of the data to/from the base station through the transmission and reception frequency band may include acquiring data provided by the transmission and reception frequency band through filtering.

The transmitting/receiving of the data to/from the base station through the transmission and reception frequency band may include providing data to the base station at a predetermined time through the transmission and reception frequency band.

In another example embodiment, there is provided a data transmission and reception method for machine type communication (MTC) service, in which a base station transmits/receives data to/from at least one MTC device, including: providing frequency band information indicating a frequency band allocated for data transmission/reception to/from the MTC device; and transmitting/receiving data to/from the MTC device through the frequency band indicated by the frequency band information.

The providing of the frequency band information indicating the frequency band allocated for data transmission/reception to/from the MTC device may include further providing at least one piece of information of paging information and timing information for data transmission/reception to/from the MTC device.

The providing of the frequency band information indicating the frequency band allocated for data transmission/reception to/from the MTC device may include providing frequency band information to the MTC device through a broadcast channel.

The providing of the frequency band information indicating the frequency band allocated for data transmission/reception to/from the MTC device may include providing the frequency band information through a minimum bandwidth that is supported by the MTC device.

The transmitting/receiving of the data to/from the MTC device through the frequency band included in the frequency band information may include receiving the data from the MTC device at a predetermined time through the frequency band.

In another example embodiment, there is provided a machine type communication (MTC) device including: a setting unit configured to set a frequency band allocated to the MTC device in a frequency band supported by a base station, to a transmission and reception frequency band; and a transceiver configured to transmit/receive data to/from the base station through the transmission and reception frequency band set by the setting unit.

The setting unit may set a frequency band allocated to the MTC device to a transmission and reception frequency band, based on band information received from the base station or based on unique information stored in the MTC device.

The transceiver may acquire data provided by the transmission and reception frequency band through filtering.

In still another example embodiment, there is provided a base station including: a generator configured to generate frequency band information indicating a frequency band allocated for data transmission/reception to/from at least one machine type communication (MTC) device; and a transceiver configured to provide the frequency band information indicating the frequency band to the MTC device, and to transmit/receive data to/from the MTC device through the frequency band indicated by the frequency band information.

As described above, according to the present invention, a base station provides an MTC device with frequency band information indicating a frequency band allocated for data transmission/reception to/from the MTC device, and the MTC device transmits/receives data to/from the base station based on the frequency band information received from the base station. That is, since a base station supporting a wide band and an MTC device supporting a narrow band transmit/receive data through an allocated frequency band, effective data transmission and reception between the base station and the MTC device is possible.

### BRIEF DESCRIPTION OF DRAWINGS

Example embodiments of the present invention will become more apparent by describing in detail example embodiments of the present invention with reference to the accompanying drawings, in which:

FIG. 1 is a view for explaining the concept of a communication system for providing machine type communication (MTC) service to which the present invention is applied;

FIG. 2 is a flowchart illustrating a data transfer method for MTC service, according to an example embodiment of the present invention;

FIG. 3 is a view for explaining downlink transmission according to an example embodiment of the present invention;

FIG. 4 is a view for explaining uplink transmission according to an example embodiment of the present invention;

FIG. 5 is a flowchart illustrating a data transfer method for MTC service, according to another example embodiment of the present invention;

FIG. 6 is a block diagram illustrating a communication system for providing MTC service, according to an example embodiment of the present invention;

FIG. 7 is a block diagram illustrating a transmitting terminal of a transceiver, according to an example embodiment of the present invention; and

FIG. 8 is a block diagram illustrating a receiving terminal of a transceiver, according to an example embodiment of the present invention.

### DESCRIPTION OF EXAMPLE EMBODIMENTS

Example embodiments of the present invention are described below in sufficient detail to enable those of ordinary skill in the art to embody and practice the present invention. It is important to understand that the present invention may be embodied in many alternate forms and should not be construed as limited to the example embodiments set forth herein.

It will be understood that, although the terms first, second, A, B, etc. may be used herein in reference to elements of the invention, such elements should not be construed as limited by these terms. For example, a first element could be termed a second element, and a second element could be termed a first element, without departing from the scope of the present invention. Herein, the term “and/or” includes any and all combinations of one or more referents.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements. Other words used to describe relationships between elements should be interpreted in a like fashion (i.e., “between” versus “directly between,” “adjacent” versus “directly adjacent,” etc.).

The terminology used herein to describe embodiments of the invention is not intended to limit the scope of the invention. The articles “a,” “an,” and “the” are singular in that they have a single referent, however the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art to which this invention belongs. It will be further understood that terms in common usage should also be interpreted as is customary in the relevant art and not in an idealized or overly formal sense unless expressly so defined herein.

Hereinafter, embodiments of the present invention will be described in detail with reference to the appended drawings. In the following description, for easy understanding, like numbers refer to like elements throughout the description of the figures, and the same elements will not be described further.

In this specification, a communication system may include a 2G mobile communication network (for example, Global System for Mobile communication (GSM), Code Division Multiple Access (CDMA), etc.), wireless Internet (for example, a Long Term Evolution (LTE) network, Wireless Fidelity (WiFi), etc.), Personal Internet (PI) (for example, Wireless Broadband Internet (WiBro), WiMax (World Interoperability for Microwave Access), etc.), or a mobile communication network (for example, a 3G mobile communication network, such as Wideband Code Division Multiple Access (WCDMA) or CDMA2000, High Speed Downlink Packet Access (HSDPA), or High Speed Uplink Packet Access (HSUPA)) supporting packet transmission.

Also, in this specification, a machine type communication (MTC) device may include a mobile station, a mobile terminal, a subscriber station, a portable subscriber station, user equipment (UE), an access terminal (AT), a terminal for machine-to-machine (M2M) communication, a terminal for a machine-oriented communication (MOC), a sensor used in a Ubiquitous Sensor Network (USN), etc. Also, the MTC device may support all or a part of functions that are provided by the mobile station, the mobile terminal, the subscriber station, the portable subscriber station, the UE, the AT, the terminal for M2M communication, the terminal for MOC, the sensor used in the Ubiquitous Sensor Network (USN), etc.

Devices that can communicate with an MTC device may include a desktop computer, a laptop computer, a tablet PC, a wireless phone, a mobile phone, a smart phone, an e-book, a portable multimedia player (PMP), a portable game, a navigation system, a digital camera, a digital multimedia broadcasting (DMB) player, a digital audio recorder, a digital audio player, a digital picture recorder, a digital picture player, a digital video recorder, a digital video player, various sensors, etc.

Also, in this specification, a base station may include an Access Point (AP), a radio access station, Node B, evolved NodeB (eNodeB), a base transceiver station, a Mobile Multihop Relay (MMR)-BS, etc. Also, the base station may support all or a part of functions that are provided by the AP, the radio access station, the Node B, the eNodeB, the base transceiver station, the MMR-BS, etc.

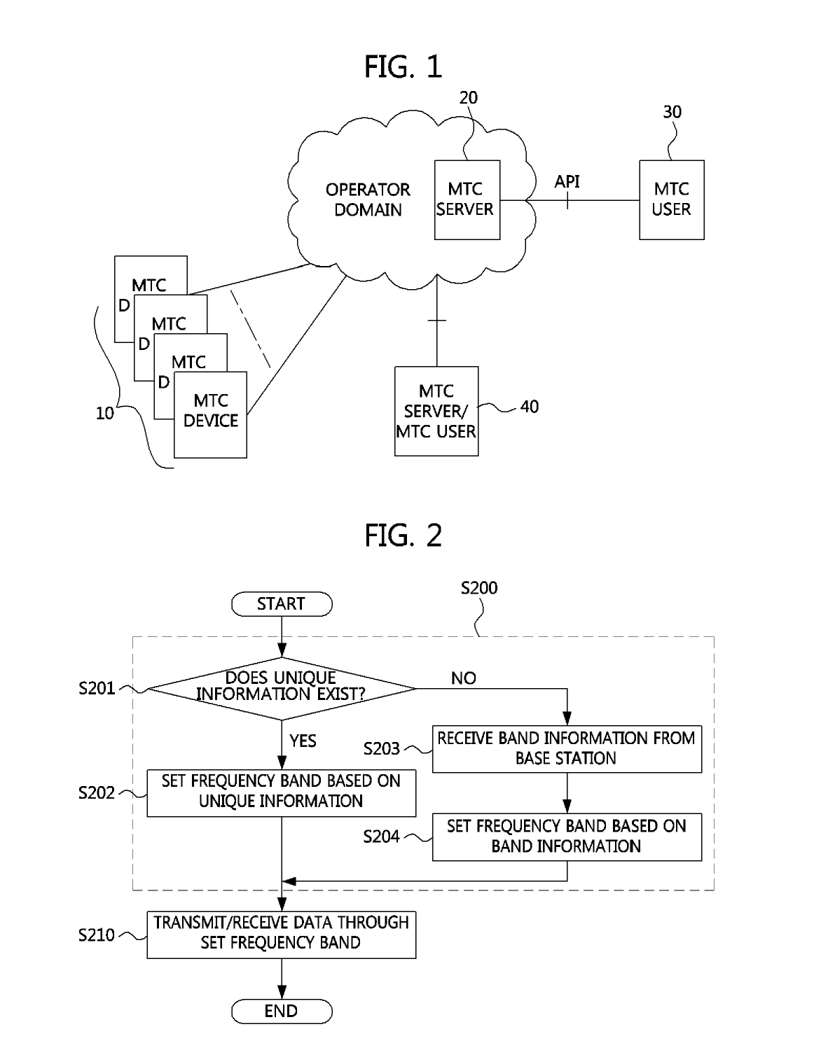

FIG. 1 is a view for explaining the concept of a communication system for providing a machine type communication (MTC) service to which the present invention is applied. Referring to FIG. 1, the communication system may include at least one MTC device 10, an MTC server 20, and an MTC user 30. Alternatively, the communication system may include at least one MTC device 10 and an MTC server/MTC user 40. Here, the MTC server 20 may be located in or out of an operator domain. If the MTC server 20 is located out of the operator domain, the MTC server 20 and the MTC user 30 may be implemented as the MTC server/MTC user 40.

The MTC device 10 may communicate with the MTC server 20, the MTC server/MTC user 40, and other MTC devices through a Public Land Mobile Network (PLMN). The MTC server 20 may communicate with the PLMN, and communicate with the MTC device 10 through the PLMN. The MTC server 20 may have an interface accessible by the MTC user 30, and provide service for the MTC user 30 through the interface. The MTC user 30 may use the service provided by the MTC server 20.

The operator domain may control the MTC server 20, and also provide an Application Programming Interface (API) on the MTC server 20. The MTC user 30 may access the MTC server 20 in the operator domain through the API. If the MTC server 20 is located out of the operator domain, the operator domain may not control the MTC server 20.

FIG. 2 is a flowchart illustrating a data transfer method for MTC according to an example embodiment of the present invention.

Referring to FIG. 2, the data transfer method for MTC may include operation S200 of setting a predetermined, allocated frequency band in a frequency band supported by a base station, to a transmission and reception frequency band, and operation S210 of transmitting/receiving data to/from the base station through the predetermined, allocated frequency band. Operations S200 and S210 may be performed by an MTC device.

Operation S200 may include operation S201 of determining whether unique information exists in the MTC device, operation S202 of setting the transmission and reception frequency band based on the unique information if the unique information exists in the MTC device, operation S203 of receiving band information from the base station if no unique information exists in the MTC device, and operation S204 of setting the transmission and reception frequency band based on the band information received from the base station.

Here, the unique information of the MTC device may be an identifier (ID) allocated to the MTC device when the MTC device is manufactured or when the MTC device is registered in a communication system (that is, a communication system providing MTC service). The unique information of the MTC device may include frequency band information indicating a frequency band that is used for communication with the base station so that the MTC device can transmit/receive data to/from the base station using the frequency band information included in the unique information.

Also, the band information may include frequency band indicating a frequency band that is used for communication between the MTC device and the base station, and the MTC device can transmit/receive data to/from the base station using the frequency band information included in the band information. The unique information and the band information may include at least one piece of information of timing information and paging information, as well as frequency band information.

In operation S201 of determining whether unique information exists in the MTC device, if the MTC device searches for unique information therein and finds unique information, the process proceeds to operation S202, and if the MTC device finds no unique information, the process proceeds to operation S203.

In operation S202, when unique information exists in the MTC device, the MTC device sets a transmission and reception frequency band to a frequency band included in the unique information.

In operation S203 in which the MTC device receives band information from the base station, the MTC device may detect a broadcast channel, and receive the band information from the base station through the broadcast channel. The broadcast channel may be a Physical Broadcast Channel (PBCH), and the MTC device may receive a Master Information Block (MIB) including band information through the PBCH.

The band information may be transmitted to the MTC device through a minimum bandwidth that is supported by at least one MTC device. That is, since MTC devices support narrow bands (for example, 1.4 MHz, 3 MHz, 5 MHz, 10 MHz, etc.), band information may be transmitted to the corresponding MTC device through a bandwidth of 1.4 MHz, which is a minimum bandwidth among narrow bands.

In operation S204, a frequency band indicated by the band information received in operation S203 is set to a transmission and reception frequency band. That is, the MTC device may receive information (for example, frequency band information, timing information, paging information, etc.) related to control through a center frequency band in a frequency band supported by the base station, or may receive information related to user data through a frequency band indicated by unique information or band information.

In operation S210, the MTC device may receive/transmit data from/to the base station through the frequency band set based on the unique information or through the frequency band set based on the band information received from the base station.

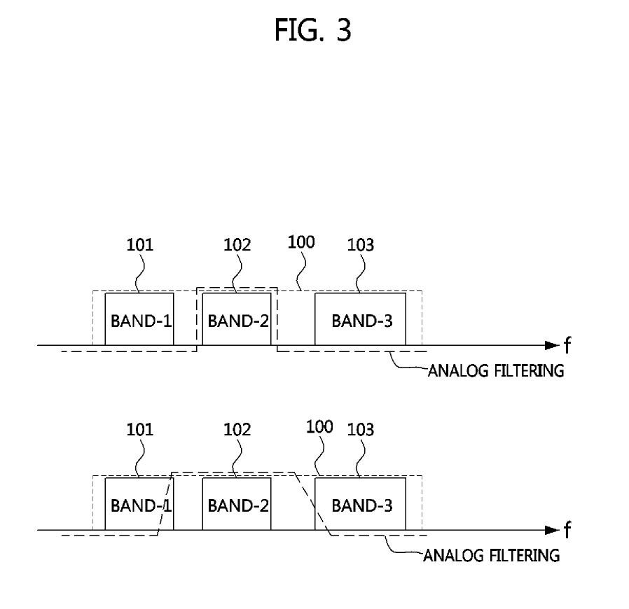

FIG. 3 is a view for explaining downlink transmission according to an example embodiment of the present invention, and a method for downlink transmission between a base station and MTC devices will be described in detail with reference to FIG. 3, below.

In FIG. 3, a band 100 is a frequency band supported by the base station, a band-1 101 is a frequency band allocated to a first MTC device, a band-2 102 is a frequency band allocated to a second MTC device, and a band-3 103 is a frequency band allocated to a third MTC device.

The first MTC device may communicate with the base station through the band-1 101 to acquire data from the base station, the second MTC device may communicate with the base station through the band-2 102 to acquire data from the base station, and the third MTC device may communicate with the base station through the band-3 103 to acquire data from the base station.

When each MTC device tries to acquire data provided through a band allocated to itself, the MTC device may use analog filtering, for example, sharp analog filtering or loose analog filtering to acquire the data provided through the allocated band. The MTC device acquires data through analog filtering, and applies Fast Fourier Transform (FFT) that is two or more times greater than the allocated band, to the acquired data, thereby eliminating interference caused by other signals.

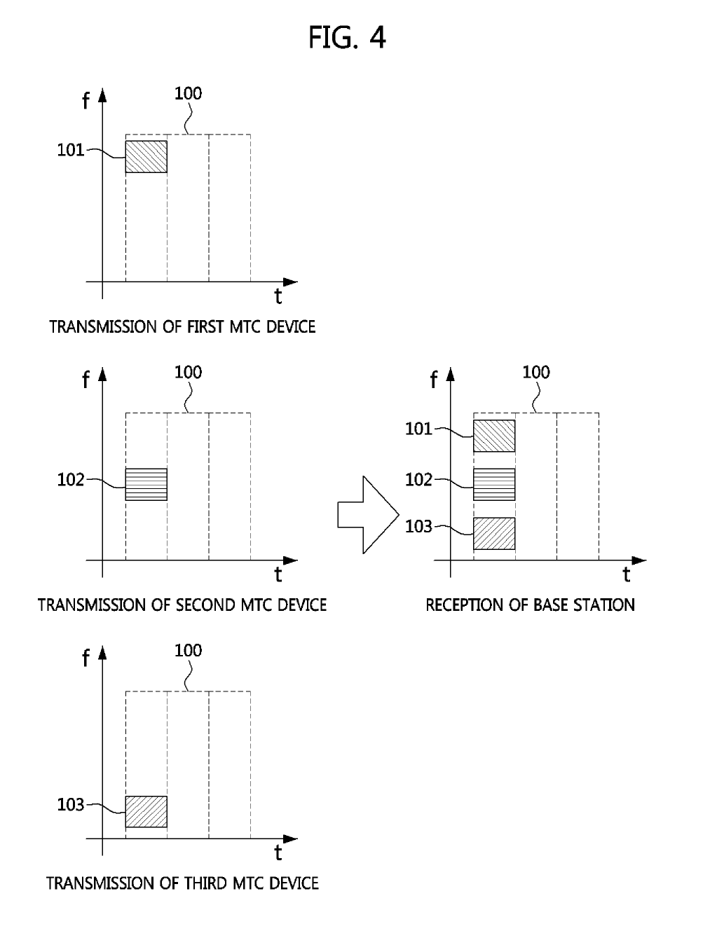

FIG. 4 is a view for explaining uplink transmission according to an example embodiment of the present invention, and a method for uplink transmission between a base station and MTC devices will be described in detail with reference to FIG. 4, below.

In FIG. 4, a band 100 is a frequency band supported by the base station, a band-1 101 is a frequency band allocated to a first MTC device, a band-2 102 is a frequency band allocated to a second MTC device, and a band-3 103 is a frequency band allocated to a third MTC device.

The first MTC device may provide data to the base station through the band-1 101, the second MTC device may provide data to the base station through the band-2 102, and the third MTC device may provide data to the base station through the band-3 103. At this time, each MTC device may provide data to the base station through an allocated band at a predetermined time. That is, upon uplink transmission between the base station and the MTC device, the MTC device may transmit data to the base station at a predetermined time in synchronization of the base station. Here, the MTC device may receive temporal information indicating the predetermined time from the base station through the allocated frequency band.

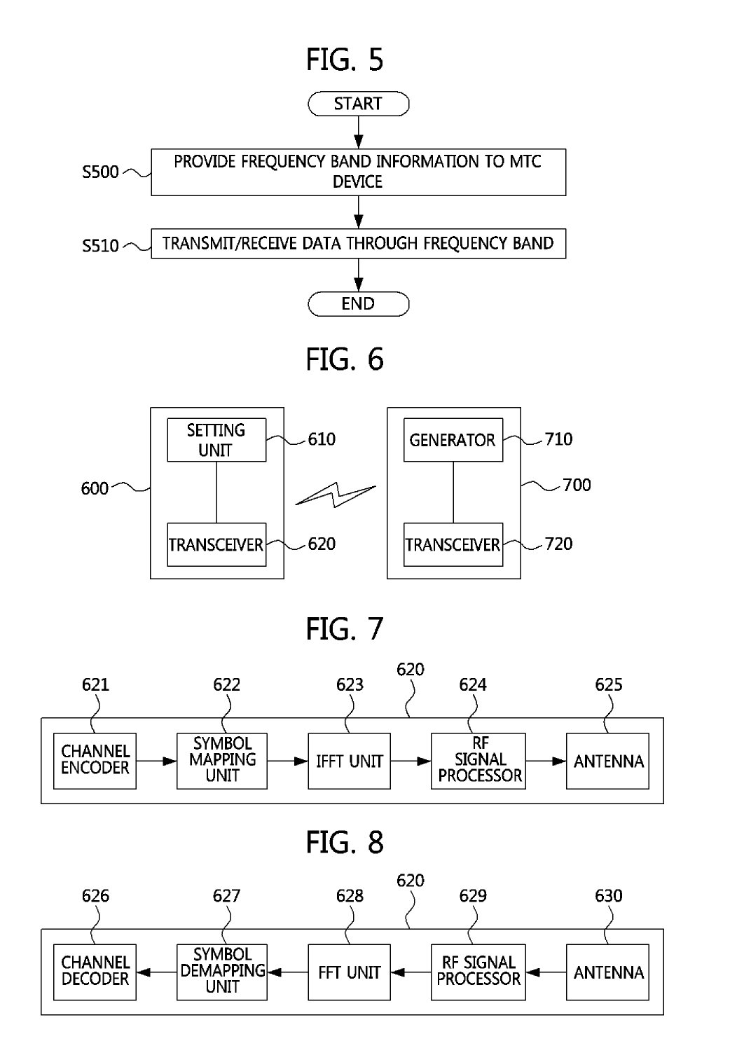

FIG. 5 is a flowchart illustrating a data transfer method for MTC service according to another example embodiment of the present invention.

Referring to FIG. 5, the data transfer method for MTC service may include operation S500 of providing at least one MTC device with frequency band information indicating a frequency band allocated for data transmission and reception, and operation S510 of transmitting/receiving data to/from at least one MTC device through the frequency band indicated by the frequency band information. Operations S500 and S510 may be performed by a base station.

In operation S500, the base station provides band information to at least one MTC device, wherein the base station may provide band information to the MTC device through a broadcast channel.

Here, the band information may include frequency band information indicating a frequency band allocated for data transmission and reception between the base station and the MTC device, and the base station and the MTC device may exchange data through the allocated frequency band. The base station may allocate frequency bands to individual MTC devices such that the frequency bands allocated to the MTC devices overlap or do not overlap.

The broadcast channel may be a PBCH, and in this case, the base station may provide a MIB including band information to an MTC device through the PBCH.

The base station may provide band information to the MTC device through a minimum bandwidth that is supported by the MTC device. That is, since the MTC device supports a narrow band (for example, 1.4 MHz, 3 MHz, 5 MHz, 10 MHz, etc.), the base station may provide band information to the MTC device through a bandwidth of 1.4 MHz, which is a minimum bandwidth among narrow bands. The base station may provide band information periodically or aperiodically to the MTC device through the broadcast channel.

In operation S500, the base station may further provide the MTC device with at least one piece of information of paging information and timing information for data transmission and reception, as well as the band information.

In operation S510, the base station transmits/receive data to/from the at least one MTC device through the frequency band indicated by the frequency band information.

In regard of downlink transmission between a base station and MTC devices as described above with reference to FIG. 3, if the base station allocates a band-1 101 to a first MTC device, the base station may provide data to the first MTC device through the band-1 101, if the base station allocates a band-2 102 to a second MTC device, the base station may provide data to the second MTC device through the band-2 102, and if the base station allocates a band-3 103 to a third MTC device, the base station may provide data to the third MTC device through the band-3 103. At this time, if bands allocated to a plurality of MTC devices overlap, the base station may differentiate transmission timings with respect to the plurality of MTC devices using the overlapping bands, or may divide the overlapping bands into different frequency areas, and transmit data through the respective divided frequency areas.

In regard of uplink transmission between a base station and MTC devices as described above with reference to FIG. 4, if the base station allocates a band-1 101 to a first MTC device, the base station may receive data provided through the band-1 101 from the first MTC device, if the base station allocates a band-2 102 to a second MTC device, the base station may receive data provided through the band-2 102 from the second MTC device, and if the base station allocates a band-3 103 to a third MTC device, the base station may receive data provided through the band-3 103 from the third MTC device.

At this time, the base station may receive data from at least one MTC device at a predetermined time. That is, the base station may be synchronized with at least one MTC device to receive data provided at a predetermined time, perform FFT on symbols including the data received from the MTC device, and demodulate the symbols subject to FFT according to the frequency band allocated to the MTC device.

The data transfer method for MTC service has been described above in detail, and hereinafter, a system, a base station, and an MTC device for MTC service, according to example embodiments of the present invention, will be described in detail below.

FIG. 6 is a block diagram illustrating a communication system for providing MTC service, according to an example embodiment of the present invention.

Referring to FIG. 6, the communication system for MTC service may include an MTC device 600 and a base station 700.

The MTC device 600 may include a setting unit 610 for setting a frequency band allocated to the MTC device 600 in a frequency band supported by the base station 700, to a transmission and reception frequency band, and a transceiver 620 for transmitting/receiving data to/from the base station through the transmission and reception band.

The setting unit 610 may set a frequency band allocated to the MTC device 600 to a transmission and reception frequency band, based on band information received from the base station 700 or unique information stored in the MTC device 600. That is, if unique information exists in the MTC device 600, the setting unit 610 may set a transmission and reception frequency band based on the unique information, and if no unique information exists in the MTC device 600, the setting unit 610 may receive band information from the base station 700, and set a transmission and reception frequency band based on the band information received from the base station 700.

Here, the unique information of the MTC device 600 may be an identifier (ID) allocated to the MTC device 600 when the MTC device 600 is manufactured or when the MTC device 600 is registered in a communication system (that is, a communication system providing MTC service). The unique information of the MTC device 600 may include frequency band information indicating a frequency band that is used for communication with the base station 700 so that the MTC device 600 can transmit/receive data to/from the base station using the frequency band information included in the unique information.

Also, the band information may include frequency band information indicating a frequency band that is used for communication between the MTC device 600 and the base station 700, and the MTC device 600 can transmit/receive data to/from the base station 700 using the frequency band information included in the band information. The unique information and the band information may include at least one piece of information of timing information and paging information, as well as the frequency band information.

The setting unit 610 may receive the band information from the base station 700 through a broadcast channel. The broadcast channel may be a PBCH, and in this case, the setting unit 610 may receive a MIB including band information from the PBCH.

The band information may be provided to the MTC device 600 through a minimum bandwidth that is supported by the MTC device 600. That is, since the MTC device 600 supports a narrow band (for example, 1.4 MHz, 3 MHz, 5 MHz, 10 MHz, etc.), band information may be provided to the corresponding MTC device 600 through a bandwidth of 1.4 MHz, which is a minimum bandwidth among narrow bands. The MTC device 600 may receive the band information provided through the broadcast channel periodically or aperiodically.

The transceiver 620 may transmit/receive data to/from the base station 700 through the frequency band set based on the unique information of the MTC device 600, or through the frequency band set based on the band information received from the base station 700.

In regard of downlink transmission between the base station 700 and the MTC device 600 as described above with reference to FIG. 3, a first MTC device may communicate with the base station 700 through a band-1 101 allocated to the first MTC device to acquire data from the base station 700, a second MTC device may communicate with the base station 700 through a band-2 102 allocated to the second MTC device to acquire data from the base station 700, and a third MTC device may communicate with the base station 700 through a band-3 103 allocated to the third MTC device to acquire data from the base station 700.

When each MTC device 600 tries to acquire data provided through a band allocated to itself, the MTC device 600 may use analog filtering, for example, sharp analog filtering or loose analog filtering to acquire the data provided through the allocated band. The MTC device 600 acquires data through analog filtering, and applies Fast Fourier Transform (FFT) that is two or more times greater than the allocated band, to the acquired data, thereby eliminating interference caused by other signals.

In regard of uplink transmission between the base station 700 and the MTC device 600 as described above with reference to FIG. 4, the first MTC device may provide data to the base station 700 through the band-1 101, the second MTC device may provide data to the base station 700 through the band-2 102, and the third MTC device may provide data to the base station 700 through the band-3 103.

At this time, each MTC device 600 may provide data to the base station 700 at a predetermined time through an allocated band. That is, upon uplink transmission between the base station 700 and the MTC device 600, the MTC device 600 may be synchronized to the base station 700 and then transmit data to the base station 700 at a predetermined time. The MTC device 600 may receive temporal information indicating the predetermined time from the base station 700 through a channel providing control information, or through the frequency band allocated to the MTC device 600.

In the current example, the setting unit 610 and the transceiver 620 are shown as separate components, however, the setting unit 610 and the transceiver 620 may be integrated into a single unit, that is, the setting unit 610, and the transceiver 620 may be implemented as a single physical device or a single module. Also, the setting unit 610 and the transceiver 620 each may be implemented as a single physical device, as a plurality of physical devices, or as a group.

The base station 700 may include a generator 710 and a transceiver 720. The generator 710 generates band information indicating a frequency band for data transmission/reception to/from at least one MTC device 600. The transceiver 720 provides the band information to the MTC device 600, and transmits/receives data to/from the MTC device 600 through the frequency band indicated by the band information.

Here, the band information may include information about a frequency band allocated for data transmission and reception between the base station 700 and the MTC device 600, and the base station 700 and the MTC device 600 receive/transmit data through the allocated frequency band. The base station 700 may allocate frequency bands to individual MTC devices (600 for each) such that the frequency bands allocated to the MTC devices overlap or do not overlap.

The transceiver 720 may provide the band information to the MTC device through a PBCH, and in this case, the transceiver 720 may provide a MIB including the band information to the MTC device 600 using the PBCH.

The transceiver 720 may provide the band information to the MTC device 600 through a minimum bandwidth that is supported by the MTC device 600. That is, since the MTC device 600 supports a narrow band (for example, 1.4 MHz, 3 MHz, 5 MHz, 10 MHz, etc.), the transceiver 720 may provide the band information to the MTC device 600 through a bandwidth of 1.4 MHz, which is a minimum bandwidth among narrow bands. The transceiver 720 may provide the band information periodically or aperiodically to the MTC device 600 through a broadcast channel.

The transceiver 720 may further provide at least one piece of information of paging information and timing information for data transmission and reception, as well as the band information, to the MTC device 600.

The transceiver 720 may transmit/receive data to/from the MTC device 600 through the frequency band indicated by the frequency band information.

In regard of downlink transmission between the base station 700 and the MTC device 600 as described above with reference to FIG. 3, if the base station 700 allocates a band-1 101 to a first MTC device, the base station 700 may provide data to the first MTC device through the band-1 101, if the base station 700 allocates a band-2 102 to a second MTC device, the base station 700 may provide data to the second MTC device through the band-2 102, and if the base station 700 allocates a band-3 103 to a third MTC device, the base station 700 may provide data to the third MTC device through the band-3 103. At this time, if bands allocated to a plurality of MTC devices (600 for each) overlap, the base station 700 may differentiate transmission timings with respect to the plurality of MTC devices 600 using the overlapping bands.

In regard of uplink transmission between the base station 700 and the MTC device 600 as described above with reference to FIG. 4, if the base station 700 allocates a band-1 101 to a first MTC device, the base station 700 may receive data from the first MTC device through the band-1 101, if the base station 700 allocates a band-2 102 to a second MTC device, the base station 700 may receive data from the second MTC device through the band-2 102, and if the base station 700 allocates a band-3 103 to a third MTC device, the base station 700 may receive data from the third MTC device through the band-3 103. At this time, the base station 700 may receive data from at least one MTC device 600 at a predetermined time. That is, the base station 700 may perform FFT on symbols including data received from at least one MTC device 600, and demodulate the symbols subject to FFT according to a frequency band allocated to the MTC device 600.

In the current embodiment, the generator 710 and the transceiver 720 are shown as separate components, however, the generator 710 and the transceiver 720 may be integrated into a single unit, that is, the generator 710 and the transceiver 720 may be implemented as a single physical device or a single module. Also, the generator 710 and the transceiver 720 each may be implemented as a single physical device, as a plurality of physical devices, or as a group.

FIG. 7 is a block diagram illustrating a transmitting terminal of the transceiver 620, according to an example embodiment of the present invention.

Referring to FIGS. 6 and 7, the transmitting terminal of the transceiver 620 may include a channel encoder 621, a symbol mapping unit 622, an Inverse Fast Fourier Transform (IFFT) unit 623, an RF signal processor 624, and an antenna 625. The channel encoder 621 may perform encoding according to the quality of a frequency band set by the setting unit 610, and at this time, the channel encoder 621 may perform encoding using Adaptive Modulation and Coding (AMC). The channel encoder 621 may use convolutional code, turbo code, Low Density Parity Check (LDPC) code, etc. as a coding method, and may use BPSK, QPSK, 16QAM, 64QAM, etc. as a modulation method.

The symbol mapping unit 622 may map encoded data to symbols, and the IFFT unit 623 may modulate the symbols using an Orthogonal Frequency Division Multiple Access (OFDMA) method, and the modulated data may be transmitted to the base station 700 through the RF signal processor 625 and the antenna 625. Here, the transmitting terminal may transmit the data to the base station 700 using the frequency band set by the setting unit 610.

FIG. 8 is a block diagram illustrating a receiving terminal of the transceiver 620, according to an example embodiment of the present invention.

Referring to FIGS. 6 and 8, the receiving terminal of the transceiver 620 may include a channel decoder 626, a symbol demapping unit 627, a Fast Fourier Transform (FFT) unit 628, an RF signal processor 629, and an antenna 630. The antenna 630 may receive data through a frequency band set by the setting unit 610, and the received data is decoded through the RF signal processor 629, the FFT unit 628, the symbol demapping unit 627, and the channel decoder 626. Here, the FFT unit 628 may demodulate the data using the OFDMA method, and the channel decoder 626 may decode the data using a coding method and a modulation method used in the transmitting terminal.

The configuration and functions of the transceiver 620 included in the MTC device 600 have been described above with reference to FIGS. 6, 7, and 8, and the configuration and functions of the transceiver 720 included in the base station 700 are also the same as those of the transceiver 620 described above. That is, the transmitting terminal of the transceiver 720 may provide data to the corresponding MTC device 600 according to frequency band information generated by the generator 710, and the receiving terminal of the transceiver 720 may receive data from the MTC device 600 according to the frequency band information generated by the generator 710.

As described above, a method of allocating a frequency band to at least one MTC device and enabling the MTC device to transmit/receive data to/from a base station through the allocated frequency band, and a communication system using the method have been described in detail, however, the present invention may be applied to an example in which a frequency band is applied to a group including a plurality of devices that perform similar or the same functions, and the plurality of MTC devices included in the group transmit or receive data through the allocated frequency band. Here, each MTC device included in the group may transmit/receive data through a frequency band allocated to the MTC device at a predetermined time allocated to the MTC device. The predetermined time allocated for transmitting/receiving data to/from each MTC device may be received from the base station through a broadcast channel, or through a frequency band allocated to the MTC device. Also, each MTC device may store its own unique temporal information therein, and in this case, the MTC device may transmit/receive data to/from the base station through a frequency band allocated to the MTC device at a predetermined time indicated by the unique temporal information.

While the example embodiments of the present invention and their advantages have been described in detail, it should be understood that various changes, substitutions and alterations may be made herein without departing from the scope of the invention.

What is claimed is:

1. A data transmission and reception method for machine type communication (MTC) service, in which an MTC device transmits/receives data to/from a base station, comprising:
setting a frequency band allocated to the MTC device in a frequency band supported by the base station, to a transmission and reception frequency band; and
transmitting/receiving data to/from the base station through the transmission and reception frequency band.

2. The data transmission and reception method of claim 1, wherein the setting of the frequency band allocated to the MTC device to the transmission and reception frequency band comprises setting a frequency band allocated to the MTC device to a transmission and reception frequency band, based on band information received from the base station or based on unique information stored in the MTC device.

3. The data transmission and reception method of claim 1, wherein the setting of the frequency band allocated to the MTC device to the transmission and reception frequency band comprises:
receiving band information from the base station through a broadcast channel; and
setting a frequency band allocated to the MTC device to a transmission and reception frequency band, based on the band information.

4. The data transmission and reception method of claim 1, wherein the transmitting/receiving of the data to/from the base station through the transmission and reception frequency band comprises acquiring data provided by the transmission and reception frequency band through filtering.

5. The data transmission and reception method of claim 1, wherein the transmitting/receiving of the data to/from the base station through the transmission and reception frequency band comprises providing data to the base station at a predetermined time through the transmission and reception frequency band.

6. A data transmission and reception method for machine type communication (MTC) service, in which a base station transmits/receives data to/from at least one MTC device, comprising:
providing frequency band information indicating a frequency band allocated for data transmission/reception to/from the MTC device; and
transmitting/receiving data to/from the MTC device through the frequency band indicated by the frequency band information.

7. The data transmission and reception method of claim 6, wherein the providing of the frequency band information indicating the frequency band allocated for data transmission/reception to/from the MTC device comprises further providing at least one piece of information of paging information and timing information for data transmission/reception to/from the MTC device.

8. The data transmission and reception method of claim 6, wherein the providing of the frequency band information indicating the frequency band allocated for data transmission/reception to/from the MTC device comprises providing frequency band information to the MTC device through a broadcast channel.

9. The data transmission and reception method of claim 6, wherein the providing of the frequency band information indicating the frequency band allocated for data transmission/reception to/from the MTC device comprises providing the frequency band information through a minimum bandwidth that is supported by the MTC device.

10. The data transmission and reception method of claim 6, wherein the transmitting/receiving of the data to/from the MTC device through the frequency band included in the frequency band information comprises receiving the data from the MTC device at a predetermined time through the frequency band.

11. A machine type communication (MTC) device comprising:
a setting unit configured to set a frequency band allocated to the MTC device in a frequency band supported by a base station, to a transmission and reception frequency band; and
a transceiver configured to transmit/receive data to/from the base station through the transmission and reception frequency band set by the setting unit.

12. The MTC device of claim 11, wherein the setting unit sets a frequency band allocated to the MTC device to a transmission and reception frequency band, based on band information received from the base station or based on unique information stored in the MTC device.

13. The MTC device of claim 11, wherein the transceiver acquires data provided by the transmission and reception frequency band through filtering.

14. A base station comprising:
a generator configured to generate frequency band information indicating a frequency band allocated for data transmission/reception to/from at least one machine type communication (MTC) device; and
a transceiver configured to provide the frequency band information indicating the frequency band to the MTC device, and to transmit/receive data to/from the MTC device through the frequency band indicated by the frequency band information.

15. The base station of claim 14, wherein the transceiver provides the frequency band information indicating the frequency band allocated to the MTC device through a broadcast channel.
